(19) United States
(12) Patent Application Publication
(10) Pub. No.: US 2006/0294504 A1
(43) Pub. Date: Dec. 28, 2006

(54) Method and system to identify serial code regions

(76) Inventors: Gopalan Ramanujam, Portland, OR (US); Vasanth Tovinkere, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/170,003

(22) Filed: Jun. 28, 2005

(51) Int. Cl. G06F 9/44

(52) U.S. Cl. 717/131

(57) ABSTRACT

A method and system to identify serial code regions in applications is described. The method includes instrumenting an application's code at loop entry points and loop exit points and gathering data about a plurality of loops in the application. The data may include the amount of time spent in each loop, the number of times each loop is executed, and/or loop hierarchies. A list of the loops may be displayed based on the gathered data. One or more of the plurality of loops may be selected for threading based on the gathered data. Directives may then be inserted into the application's code to thread one or more of the plurality of loops. The threaded loops may then be simulated and any resulting errors may be displayed.

### TECHNICAL FIELD

Embodiments of the invention relate to software programming, and more specifically to identifying serial code regions in applications for parallelization.

### BACKGROUND

Many applications are not threaded to take advantage of processors with multiple cores. Threading allows code to run in parallel to increase efficiency and performance. However, it is often difficult for a programmer to know what area of their code to thread in order to yield the best performance results. Call graphing tools may be used to show the structure of the application at a function level, including the functions that are executed and parent-child relationships. However, a programmer still has to do a significant amount of work to analyze the code and to determine what is causing a lot of time to be spent in a particular function. The best area to thread may be outside of the function that is being executed most or for the most total time, since the function may be called from elsewhere in the code. Therefore, determining the best portion of the code to thread is often a trial and error process that takes a significant amount of time.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram illustrating a suitable computing environment in which certain aspects of the illustrated invention may be practiced.

FIG. 2 is a flow diagram illustrating a method according to an embodiment of the invention.

### DETAILED DESCRIPTION

Embodiments of a system and method to identify serial code regions are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

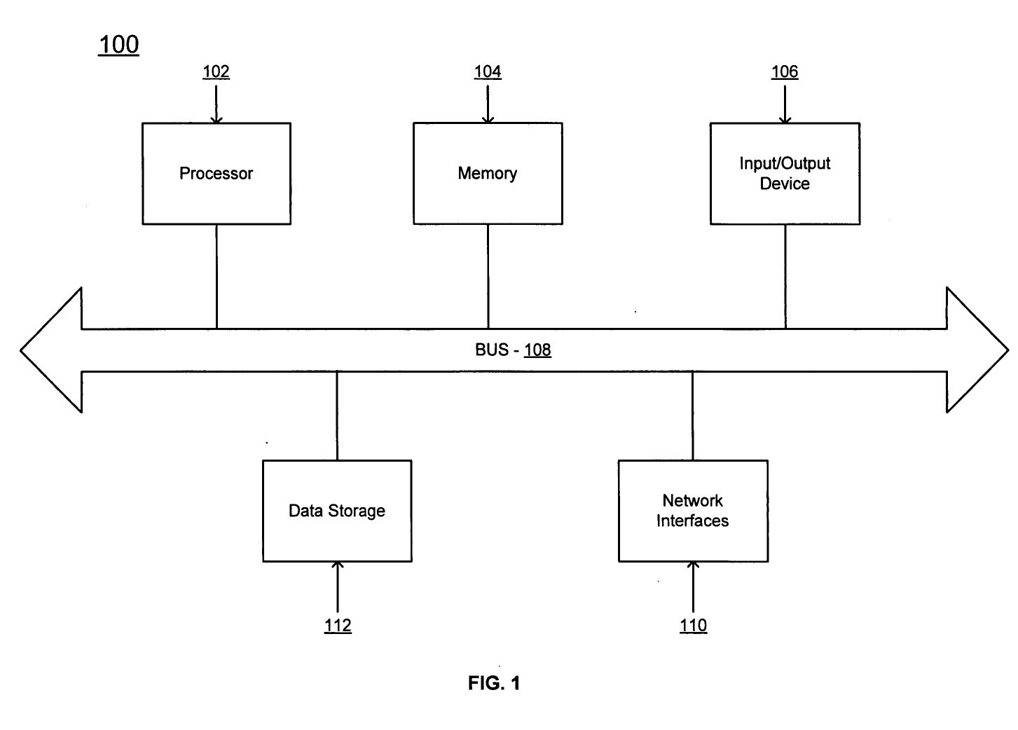

FIG. 1 is a block diagram illustrating a suitable computing environment in which certain aspects of the illustrated invention may be practiced. Methods of the invention may be implemented on a computer system 100 having components 102-112, including a processor 102, a memory 106, an Input/Output device 104, a data storage device 112, and a network interface 110, coupled to each other via a bus 108. The components perform their conventional functions known in the art and provide the means for implementing the system 100. Collectively, these components represent a broad category of hardware systems, including but not limited to general purpose computer systems, mobile or wireless computing systems, and specialized packet forwarding devices. It is to be appreciated that various components of computer system 100 may be rearranged, and that certain implementations of the present invention may not require nor include all of the above components. Furthermore, additional components may be included in system 100, such as additional processors, storage devices, memories (e.g. RAM, ROM, or flash memory), and network or communication interfaces.

As will be appreciated by those skilled in the art, the content for implementing an embodiment of the method of the invention, for example, computer program instructions, may be provided by any machine-readable media which can store data that is accessible by system 100, as part of or in addition to memory, including but not limited to cartridges, magnetic cassettes, flash memory cards, digital video disks, random access memories (RAMs), read-only memories (ROMs), and the like. In this regard, the system 100 is equipped to communicate with such machine-readable media in a manner well-known in the art.

It will be further appreciated by those skilled in the art that the content for implementing an embodiment of the method of the invention may be provided to the system 100 from any external device capable of storing the content and communicating the content to the system 100. For example, in one embodiment of the invention, the system 100 may be connected to a network, and the content may be stored on any device in the network.

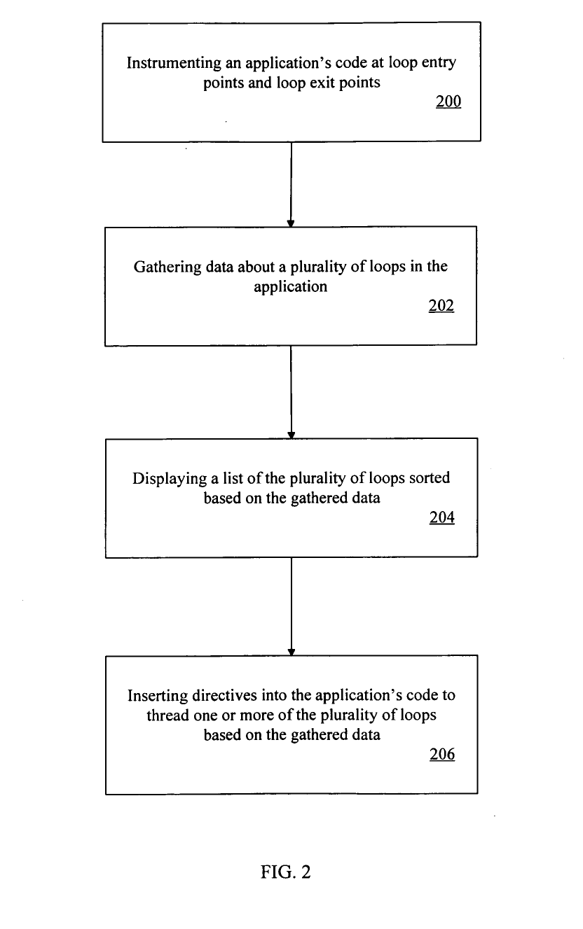

FIG. 2 illustrates a method according to one embodiment of the invention. At 200, an application's code is instrumented at loop entry and exit points. In one embodiment, a call graphing tool is used to instrument the application binary and to run the instrumented binary. At 202, data is gathered regarding a plurality of loops in the application. This data may include the time spent in each of the plurality of loops, which may include or not include the time spent in functions inside the loop. The data may also include the number of times each loop is executed, the minimum and maximum times that each loop took to execute, and loop hierarchies. The minimum and maximum times that each loop took to execute may be used to determine if any of the loops are imbalanced. Additional processing filters may be used to determine which loops, if any, should be merged into a single loop to minimize this imbalance. At 204, a list of the loops is displayed based on the gathered data. In one embodiment, the list of loops may be sorted by the amount of time spent in each loop. In one embodiment, the list of loops may be displayed according to a loop hierarchy. One or more loops may be selected for threading based on the gathered data.

At 206, directives are inserted into the application code to thread one or more of the plurality of loops. In one embodiment, compiler recognizable directives, such as pragmas, are inserted around the one or more loops selected for threading. In one embodiment, the pragmas are OpenMP pragmas. After the directives are inserted, a compiler may be invoked to recompile the application code. A thread checker, which is a software based tool to check for threading errors, may then be launched to run a simulation of the threaded loops. After the simulation, threading errors may be captured. The threading errors may be displayed. The loops may also be prioritized based on the severity of the simulation errors. A list of loops may then be displayed based on feasibility of parallelization.

In one embodiment, an automated process may be used to insert directives into the application code to thread one or more loops, invoke a compiler to recompile the application code, launch a thread checker to run a simulation of multiple threads, capture any threading errors, and report a prioritization of loops to thread based on the simulation errors.

The following is an illustrative example of inserting instrumentation around loops into the application code.

```
UniqueID LoopIdentifier;
LoopIdentifier = InstrumentationProlog ( );
For ( I = 0; I< loop_count; ++I )
    begin
        // work in the loop is done here
        Work ( );
    End
InstrumentationEpilog (LoopIdentifier);
```

In the above example, each loop is identified and an InstrumentationProlog( ) and InstrumentationEpilog( ) pair is added around the loop. The InstrumentationProlog( ) uniquely identifies the loop and the loop times are recorded by the InstrumentationEpilog( ) section of the instrumentation code. After the instrumented application is run, a list of loops may be displayed accorded to the recorded data and one or more of the loops may be selected for threading.

Thus, embodiments of a system and method to identify serial code regions have been described. While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
instrumenting an application's code at loop entry points and loop exit points;
gathering data for a plurality of loops in the application, the data including an amount of time spent in each of the plurality of loops; and
inserting directives into the application's code to thread one or more of the plurality of loops based on the gathered data.

2. The method of claim 1, wherein the gathered data includes a number of times each of the plurality of loops is executed.

3. The method of claim 1, wherein the gathered data includes a minimum time that each of the plurality of loops took to execute.

4. The method of claim 1, wherein the gathered data includes a maximum time that each of the plurality of loops took to execute.

5. The method of claim 1, wherein the gathered data includes loop hierarchies.

6. The method of claim 1, further comprising displaying a list of the plurality of loops.

7. The method of claim 6, wherein the displayed list of loops is sorted by the amount of time spent in each loop.

8. The method of claim 6, wherein the list of loops is displayed according to a loop hierarchy.

9. The method of claim 1, wherein inserting directives into the application's code to thread one or more of the plurality of loops comprises inserting pragmas around one or more of the plurality of loops.

10. The method of claim 1, further comprising simulating the threaded loops.

11. The method of claim 10, further comprising displaying a list of threading errors.

12. The method of claim 11, further comprising displaying a list of the plurality of loops that is sorted by severity of threading errors.

13. An article of manufacture comprising:
a machine accessible medium including content that when accessed by a machine causes the machine to perform operations comprising:
instrumenting an application's code at loop entry points and loop exit points;
gathering data about a plurality of loops in the application when the instrumented application code is run, the data including an amount of time spent in each of the plurality of loops;
displaying a list of the plurality of loops sorted based on the gathered data; and
selecting one or more of the plurality of loops to thread based on the gathered data.

14. The article of manufacture of claim 13, wherein the machine-accessible medium further includes content that causes the machine to perform operations comprising inserting directives into the application's code to thread one or more of the selected loops.

15. The article of manufacture of claim 14, wherein inserting directives into the application's code to thread one or more of the plurality of loops comprises inserting pragmas around the selected loops.

16. The article of manufacture of claim 14, wherein the machine-accessible medium further includes content that causes the machine to perform operations comprising simulating the threaded loops.

17. The article of manufacture of claim 16, wherein the machine-accessible medium further includes content that causes the machine to perform operations comprising generating a list of threading errors.

18. A system comprising:
a processor;
a network interface coupled to the processor; and
a machine accessible medium including content that when accessed by a machine causes the machine to perform operations comprising:
instrumenting an application's code at loop entry points and loop exit points;
gathering data for a plurality of loops in the application, the data including an amount of time spent in each of the plurality of loops; and
inserting directives into the application's code to thread one or more of the plurality of loops based on the gathered data.

19. The system of claim 18, wherein the performed operations further comprise displaying a list of the plurality of loops that is sorted by the amount of time spent in each loop.

20. The system of claim 18, wherein the performed operations further comprise simulating the threaded loops and displaying any threading errors.
